(19) United States
(12) Patent Application Publication
(10) Pub. No.: US 2004/0246502 A1
(43) Pub. Date: Dec. 9, 2004

(54) Rendering sub-sections

(76) Inventors: Dana A. Jacobsen, Boise, ID (US); John F. Mauzey, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/457,683

(22) Filed: Jun. 9, 2003

(51) Int. Cl. G06F 3/12; G06F 15/00; G06F 9/28

(52) U.S. Cl. 358/1.1; 358/1.16

(57) ABSTRACT

A system, method, and article for rendering a page for a printing device is described. The system, method, and article include partitioning a page into multiple sections, partitioning individual sections into multiple sub-sections, and rendering individual sub-sections of the section. Further, a system, method, and article in an embodiment also include a cache memory, wherein the sub-sections of the section are sized so that a sub-section raster image size is less than the cache size, so that all or most of the pixels of the sub-section raster image are rendered in the cache. Further, the system, method, and article in an embodiment also include multiple processors each configured to separately render a sub-section concurrently.

### TECHNICAL FIELD

This invention relates generally to a printing device and more particularly but not exclusively, relates to rendering a raster image for a printing device.

### BACKGROUND

The time expended to render a page into a raster image is an important criterion of printing device performance. Thus there is a strong interest in reducing the time to render a raster image. Conventional rendering apparatus render a page by partitioning the page into sections. Each section is rendered separately so that each section raster image can be separately passed to a print engine. Each section is rendered based on rendering commands stored in a section display list. The sections are sized to store a section raster image in printing device memory, to optimize the time to render a section, and to optimize the time to develop a section display list.

### SUMMARY

One embodiment of the invention includes partitioning a page into multiple sections, partitioning individual sections into multiple sub-sections, and rendering individual sub-sections of the section. One embodiment includes a cache memory and the sub-sections of the section are sized, so that a sub-section raster image size is less than the cache size, so that all or most of the pixels of the sub-section raster image are rendered in the cache. One embodiment includes multiple processors each configured to separately render a sub-section. The multiple processors are configured to render sub-sections concurrently.

### BRIEF DESCRIPTION OF THE DRAWINGS

The detailed description is described with reference to the accompanying figures.

FIG. 1 portrays an exemplary page to be rendered that is partitioned into exemplary sections.

FIG. 2 portrays an exemplary page to be rendered that is partitioned into exemplary sections, where the sections themselves are partitioned into exemplary sub-sections.

FIG. 3 portrays a block diagram of an exemplary rendering apparatus that has a cache memory, and is configured to render a page by rendering sub-sections generally in the cache memory.

FIG. 4 portrays a block diagram of an exemplary rendering apparatus that has multiple processors, and is configured to render a page by concurrently rendering multiple sub-sections.

FIG. 5 is a flow chart portraying an exemplary method of rendering a page by partitioning the page into sub-sections, and rendering each sub-section separately.

FIG. 6 is a flow chart portraying an exemplary method of rendering a page by partitioning the page into sub-sections, receiving a page description, building a file of rendering commands, and rendering each sub-section separately based on the file of rendering commands.

FIG. 7 is a flow chart portraying an exemplary method of rendering a page by partitioning the page into sub-sections, rendering each sub-section separately, and rendering the more frequently accessed pixels of each sub-section in a cache memory.

FIG. 8 is a flow chart portraying an exemplary method of rendering a page by partitioning the page into sub-sections, and rendering each sub-section of each section separately by rendering sub-sections concurrently

### DETAILED DESCRIPTION

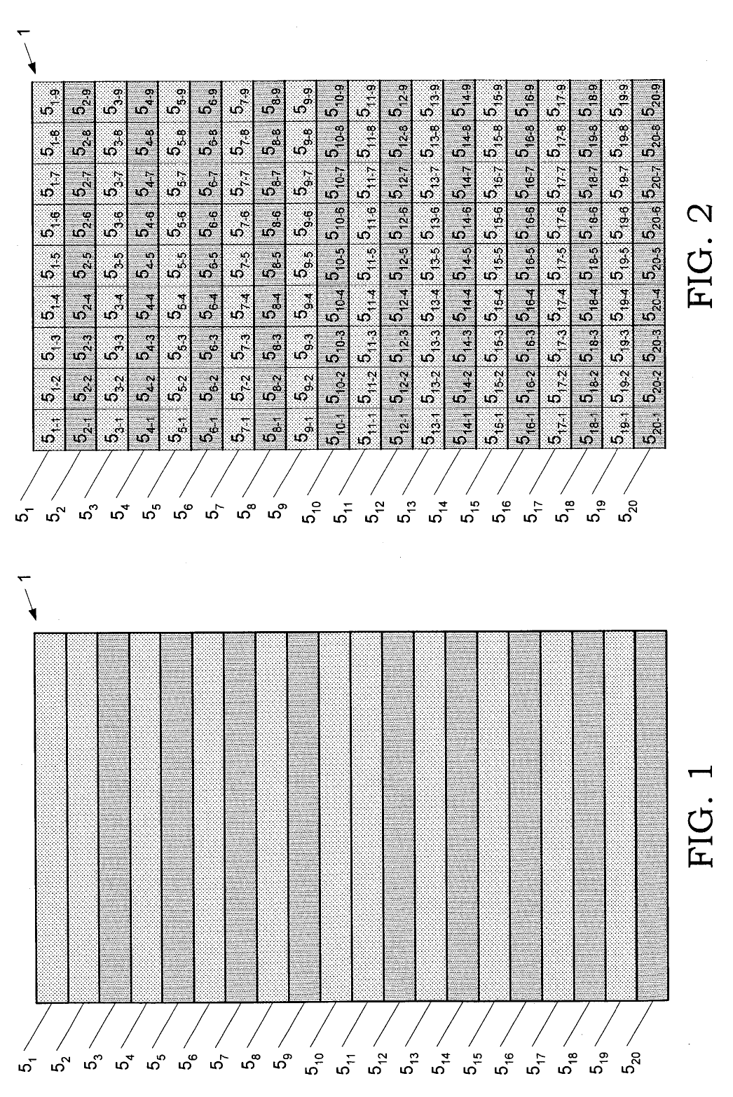

A rendering apparatus to render a page to-be printed on a printing device is described. A page is partitioned into sections. Each section is partitioned into multiple separate sub-sections, and separately rendered. A page, a section, and a sub-section, are described with reference to FIGS. 1-2.

Referring now to the figures, and particularly FIG. 1 thereof, there is shown a page 1 partitioned into exemplary multiple non-overlapping sections 5ᵢ that together constitute the page 1. Illustratively, the page 1 is partitioned into 20 non-overlapping sections 5₁-5₂₀. Typically, and as portrayed in FIG. 1, each section 5ᵢ spans the entire page 1 in one direction, and spans part of the page 1 in the other direction. In this art, a section is also commonly termed a “strip,” a band,” and a “zone.” Each section 5ᵢ may be sent to the print engine 310 separately, in order to avoid storing a raster image of the entire page and to pass the section to the print engine as it is rendered, to keep up with the action of the print engine.

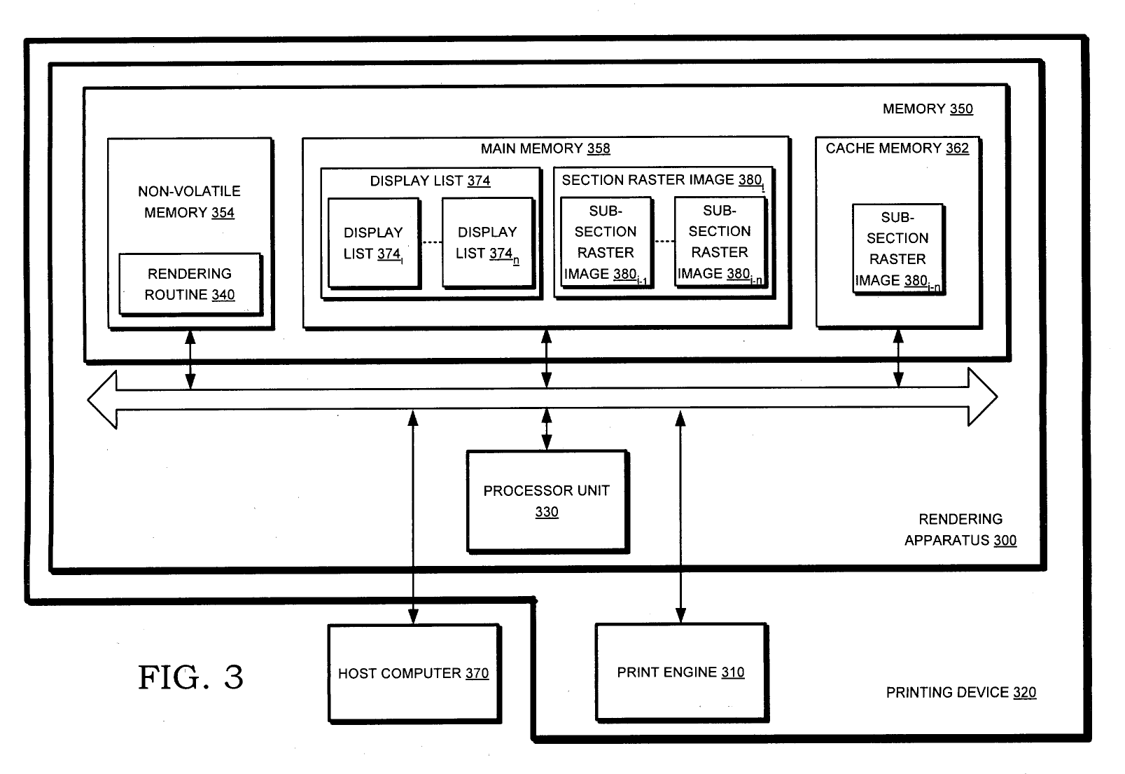

Referring now to FIG. 2, each section 5ᵢ of a page 1 is shown partitioned into exemplary multiple non-overlapping sub-sections constituting the section 5ᵢ. Illustratively, each section 5ᵢ is partitioned into 9 non-overlapping sub-sections 5ᵢ₁-5ᵢ₋₉. Each sub-section 5₁₋₁-5₂₀₋₉, is rendered separately. The structure of a rendering apparatus, and the process of rendering a page, is further described with reference to FIGS. 3-8.

Referring now to FIG. 3, there is shown an implementation of a rendering apparatus 300 to render a raster image for a printing device. The rendering apparatus 300 renders a page a section at a time, and then provides the rendered section raster image to a print engine 310. In the portrayed implementation, the rendering apparatus 300 resides in a printing device 320. In another implementation, the rendering apparatus 300 may reside outside the printing device 320. The rendering apparatus 300 includes a processor unit 330 having at least one processor configured to execute a rendering routine 340. The rendering routine 340 is stored in a memory 350.

The memory 350 is implemented here to include a non-volatile memory 354 that stores the rendering routine 340. In one implementation, the rendering routine 340, under the control of an operating system, in operation is read from the non-volatile memory 354. Then the rendering routine 340 is loaded into a main memory 358 of the memory 350, and then executed from the main memory 358. In one implementation, the rendering routine 340 is stored in the non-volatile memory 354 in a compressed form, and then during an initial operation of the rendering apparatus 300, is loaded into the main memory 358. In the main memory 358, the rendering routine 340 is decompressed, and stored in the decompressed form. In one implementation, the rendering routine 340 is executed from the non-volatile memory 354.

The memory 350 includes a cache memory 362. The cache memory 362 is configured as a special high-speed section of the main memory 358, and/or as an independent high-speed storage device. As an independent high speed storage device, the cache memory 362 may be physically integrated within an integrated circuit that includes the processor unit 330 or physically mounted close to the processor unit 330, as an external independent device. One or more cache memory 362 modules may be present, with the first and fastest cache commonly termed “Level 1” cache, the second and next fastest cache (if present) commonly termed “Level 2” cache, and so forth. The cache memory 362 operates at a faster rate than the main memory 358. Thus, the processor unit 330 in operation reads from and writes to the cache memory 362 at a faster rate than a corresponding read from, and write to, the non-cache main memory 358. The rendering apparatus 300 stores the more frequently accessed pixels of the sub-section raster image in the cache memory 362 as it is being rendered. In one implementation, the subsection 5ᵢ and/or the cache memory 362 are together sized so that one can reliably expect all or most of the sub-section raster to fit in cache memory 362. In one implementation, the subsection 5ᵢ size is computed by the processor unit 330 before rendering the subsection 5ᵢ. In one implementation, the cache 362 has more memory than is required to at least store the more frequently accessed pixels of the sub-section raster image, to additionally store both frequently accessed display list data, program instructions, and as less frequently accessed pixels of the sub-section raster image.

In one implementation, the sub-section raster image being rendered is stored in the cache memory 362 in response to an executing replacement algorithm. A replacement algorithm generally controls the replacement of the least recently accessed data in the cache 362 with the more recently accessed data in the main memory 358. Therefore the more recently accessed data is stored in the cache memory 362 and not in the main memory 358. In another implementation, the cache memory 362 utilization is controlled by explicit program instructions, so as to store the more recently accessed pixels of the raster image of the sub-section being rendered in the cache memory 362. Data and processing instructions are initially and nominally stored in the main memory 358, and are described herein as being stored in the main memory 358. However, under the control of an executing replacement algorithm or explicit program instructions, the more recently accessed data and processing instructions arc at least partially stored in the cache memory 362 rather than in the main memory 358.

The processor unit 330, in executing the rendering routine 340, causes the rendering apparatus 300 to perform the functions described herein. The rendering apparatus 300 reads an input Page Description Language (PDL) representation of a to-be-rendered page. In one implementation, the rendering apparatus 300 converts the PDL page representation into a display list 374. A display list may be described a list of rendering commands, commonly an ordered list. The display list 374 is generally stored in the main memory 358, although in operation, the display list 374 or a portion therefore may be stored in the cache memory 362. In one implementation, the display list 374 is embodied as multiple display lists 374ᵢ, where each of the multiple display lists 374ᵢ stores the rendering commands for a separate section of the page. The rendering apparatus 300 develops the display list 374ᵢ for the section 5ᵢ by converting the received PDL description into rendering commands for those objects to be rendered that fall totally or partially within the section 5ᵢ. The objects are clipped to include the portion that falls within section 5ᵢ and to exclude the portion that falls without the section 5ᵢ. A method of converting a PDL page representation into multiple display lists 374ᵢ, each for rendering a section 5ᵢ, is illustratively described in U.S. Pat. No. 5,805,174, incorporated herein by reference. In U.S. Pat. No. 5,805,174, the term “zone” is used to represent a section. Another method is described in U.S. Pat. No. 5,129,049, incorporated herein by reference. In U.S. Pat. No. 5,129,049, the term “strip” is used to represent a section.

Dividing the page into enough sections such that the sections are sized to fit cache or dedicated memory is typically impractical. The sections are sized to store a section raster image in printing device memory, to optimize the time to render a section, and to optimize the time to develop a section display list. The amount of memory used in the section display lists grows rapidly. Processing each section has a certain amount of overhead, which means that in practice the number of sections must be limited. Often further processing on sections utilizes hardware that has limitations on the possible sizes of sections. By retaining sections and section or page display lists, but rendering sub-sections, the efficiency and practicality of the current section sizes is maintained, while allowing efficient rendering by separately sizing the sub-sections.

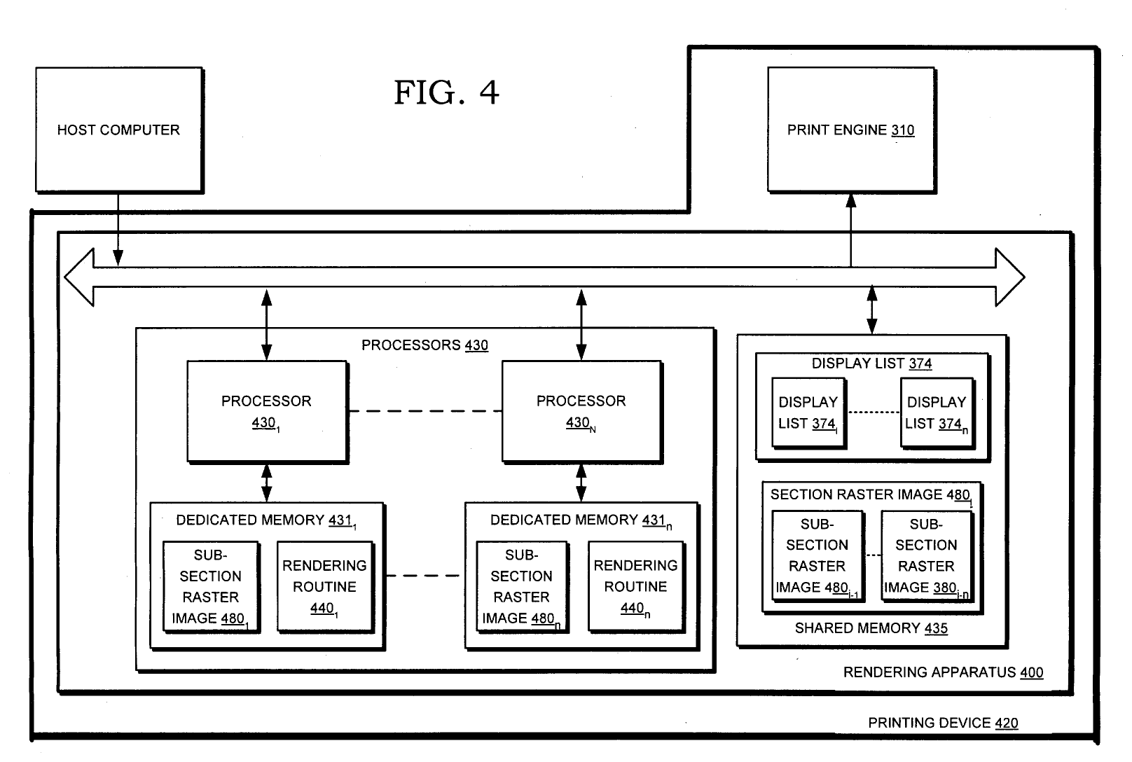

For each section 5ᵢ in FIG. 2, the rendering apparatus 300 is configured to render in sequence each sub-section 5ᵢ₋₁-5ᵢ₋₉. Each sub-section 5ᵢ₋₁-5ᵢ₋₉, and/or cache memory 362, is sized so that while a sub-section is rendered, the more frequently accessed pixels of the sub-section raster image are generally or at least approximately stored in the cache memory 362. While a section 5ᵢ is rendered, the more frequently accessed pixels of the sub-section raster image are generally or at least approximately stored in the cache 362 in response to the action of a replacement algorithm or explicit program instructions, as described above. The raster image of already-rendered sub-sections can be stored in the main memory 358, and will generally be stored in the main memory 358 in response to the action of the replacement algorithm, explicit program instructions, a cache flush, or the like as described with reference to FIG. 4. The terms “generally” and “approximately” are used to describe the data and processing instruction stored, including the pixels stored and/or rendered, in the cache memory. Under the control of a replacement algorithm or an explicit program determining cache utilization, the precise data and processing instructions that are stored in the cache is generally not predictable. They are therefore described as being “generally” and “approximately” (or the like) stored.

The sub-section raster images that have already been rendered, illustratively sub-section raster images 380ᵢ₋₁-380ᵢ₋₈, (of respective sub-sections 5ᵢ₋₁-5ᵢ₋₈ in FIG. 2), are stored in the main memory 358. The sub-section raster image of the section being rendered, raster image 380ᵢ₋₉, (of sub-section 5ᵢ₋₉ in FIG. 2) is generally or at least approximately rendered in the cache memory 362 as described above. The main memory 358 buffers the portion of the section raster image 380ᵢ that is not stored in the cache memory 362 for eventual transmission to the print engine 310.

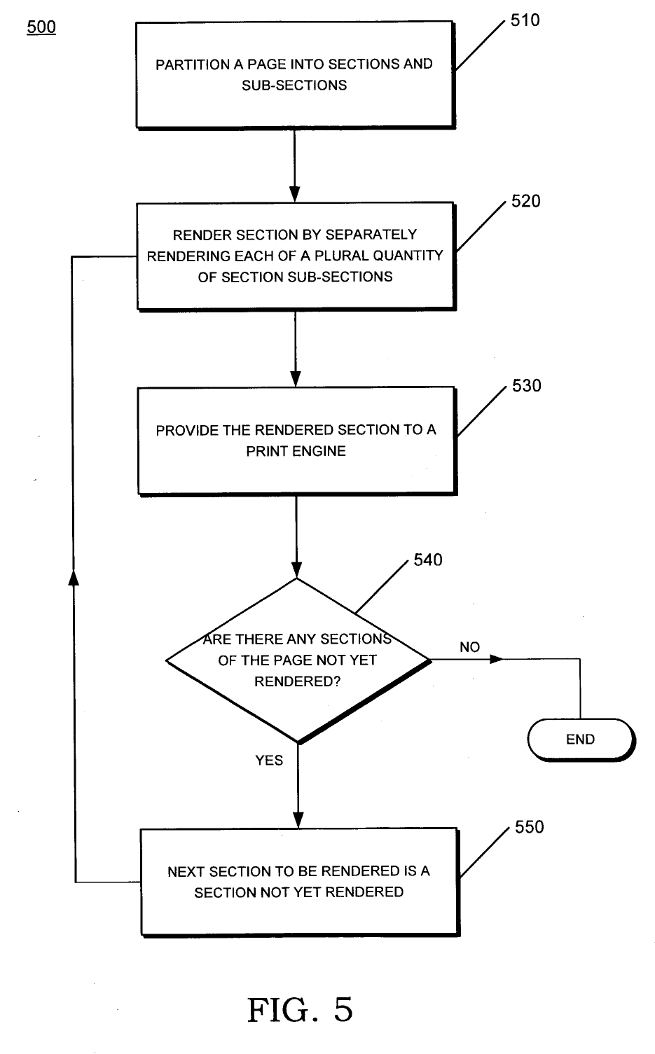

The rendered section raster image is provided to the print engine 310 from the main memory 358. In practice, the main memory may be sized to store more than one section, in order to maintain a flow of rasterized data to the print engine 310. In this implementation, the rendering apparatus 300 will both render one section in the main memory 358, and will provide an already rendered section raster image to the print engine 310. As used herein, rendering into a memory (e.g. main memory or cache memory) means to store the pixels of the developing raster image in the memory during the rendering process, In one implementation, the sub-section raster images are provided directly to the print engine 310, such as a print engine compression unit, bypassing the main memory 358. The design and action of the rendering apparatus 300 is described further with reference to FIGS. 5, 6, and 7.

Referring now to FIG. 4, there is shown an implementation of a rendering apparatus 400 to render a raster image for a printing device. The rendering apparatus 400 renders a page a section at a time, and then provides the rendered section raster image to a print engine 310.

In this implementation, the rendering apparatus 400 resides in a printing device 420. The rendering apparatus 400 includes parallel processors 430ᵢ, portrayed illustratively as “n” processors 430₁-430ₙ. Each processor 430ᵢ is configured to render at least one sub-section, and to render a sub-section concurrently with the other processors rendering at least one other sub-section. In one implementation, the quantity of sub-sections constituting a section is the same as the quantity of processors 430ᵢ, so that each processor 430ᵢ renders just one sub-section, and the sub-sections constituting a section are rendered approximately concurrently. Therefore the time to render the more time consuming sub-section raster generally determines the time to render a section.

Each portrayed processor 430ᵢ is operatively coupled to both a dedicated memory 431ᵢ, and to a shared memory 435. Illustratively, the processor 430₁ is operatively coupled to the dedicated memory 431₁, and the processor 430ₙ is operatively coupled to the dedicated memory 431ₙ. In one implementation, the dedicated memory 431ᵢ stores the raster image of the sub-section being rendered 440ᵢ. In another implementation, the dedicated memory also stores a rendering routine 440ᵢ. The dedicated memory 431ᵢ and/or the sub-section raster images 480ᵢ are sized so that the dedicated memory 431ᵢ can concurrently store both a sub-section raster image 480ᵢ and the rendering routine 440ᵢ. Each rendering routine 430ᵢ may be stored in volatile or in non-volatile memory, as described with reference to FIG. 3. After a sub-section is rendered, its raster image is stored in the shared memory 435 for buffering, and for a subsequent transmission to the print engine 310. The shared memory 435 stores the display list 374 (or other description of the page to be rendered). Each processor reads the display list 374ᵢ from the shared memory 435, and renders the sub-section 5ᵢ based on the display list 374ᵢ. The shared memory 435 stores each section raster image 480ᵢ (wherein the section raster image 480ᵢ comprises the sub-section raster images 480₁-480ₙ). The shared memory 435 acts as a buffer for each section raster image 480ᵢ, for providing each section raster image 480ᵢ to the print engine 310 at an appropriate time.

In implementations having parallel processors, there are many possible memory allotments and configurations. Some of these allotments and configurations are described. A processor may have no dedicated memory, a cache memory, or a dedicated memory that includes or does not include a cache memory. If a processor does not have a dedicated memory or cache memory, then all data and program instructions are stored in the shared memory.

If a processor has a dedicated memory that is a cache memory, then data and instructions are nominally stored in the shared memory. The more frequently accessed data and instructions are stored in the processor's cache according to an executing replacement algorithm, or explicit program instructions, as described with reference to FIG. 3. In one implementation, the size of the sub-section raster image, or of the cache memory, is such that the sub-section raster image size is less than the cache memory size. In one implementation, the size of the subsection is calculated by the processor unit 330 before rendering the sub-section. A cache flush instruction or the like loads the sub-section raster image memory into the shared memory. When a sub-section has been rendered, the raster image in the cache memory is transferred to the shared memory. Illustratively, this may be performed by explicitly writing the memory locations, or by flushing cache to write the content of the cache memory locations to the shared memory.

In one implementation having an operatively coupled dedicated memory, a sub-section raster image, a rendering routine, and/or a display list may be stored in the dedicated memory. A dedicated memory relieves traffic on a shared-memory bus. In one implementation in which the sub-section raster image, a rendering routine, and/or a display list is in a processor's dedicated memory, all respective reads and writes target the dedicated memory.

In one implementation having an operatively coupled dedicated memory, a sub-section raster image is stored in the dedicated memory, while the sub-section raster image is rendered. Typically the dedicated memory will be of a relatively small fixed size, but large enough to store the sub-section raster image. By rendering sub-sections, the raster image size is small enough to make a parallel processor system in which each processor has an operatively coupled dedicated memory feasible for many applications. After a sub-section has been rendered in dedicated memory, it is written to the shared memory. In one implementation, the sub-section raster image is written directly to a compression unit, bypassing the shared memory.

In one implementation having an operatively coupled dedicated memory, a rendering routine may be stored in the dedicated memory. The rendering routine may be stored in volatile memory and/or a non-volatile memory, described with reference to FIG. 3. A display list may be stored in the dedicated memory. A display list is a variable size, so a design decision to store a display list in the dedicated memory may depend upon a dedicated memory to store the largest section display list. In one implementation, a display list is stored partially in dedicated memory by pulling into the dedicated memory the display list data as it is used for processing. A design for accomplishing this is illustratively a rolling buffer.

The design and action of the rendering apparatus 400 is described further with reference to FIGS. 5, 6, and 8.

Referring now to FIG. 5, there is shown an exemplary method 500 of rendering a page. The method renders a section at a time, and renders each section by separately rendering each sub-section. In one implementation, the sub-sections are rendered sequentially. Illustrative apparatus that perform the method described herein are described with reference to FIGS. 3 and 4.

In block 510, a page is partitioned into sections and sub-sections. In block 520, a section of a page is rendered into a raster image by separately rendering each sub-section into a sub-section raster image. In one implementation, sub-section raster images are combined after they are developed. In one implementation, each sub-section raster image is combined to form a section raster image. In block 530, after the section raster image is rendered, the raster image is provided to a print engine. In one implementation, a sub-section raster image is separately provided to the print engine and independently of other sub-section raster images, or in conjunction with less than all the sub-section raster images. In one implementation, while a section raster image is sent to the print engine, another section raster image is being rendered. In block 540, if there is a section still to be rendered, the “YES” branch is taken from block 540 to block 550. The next section to be rendered is a section not yet rendered, and blocks 520-540 are repeated for this next section. In block 540, if there is not a section still to be rendered, (i.e. the “NO” branch is taken from block 540) then n-the page has been rendered.

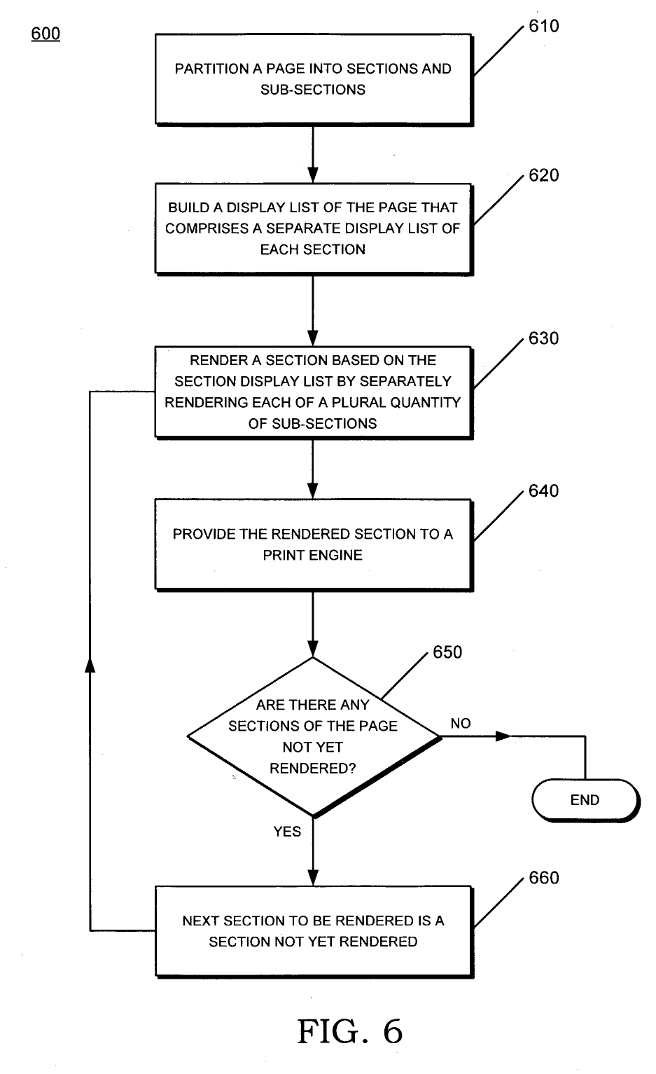

Referring now to FIG. 6, there is shown an exemplary method 600 of building a file of rendering commands, and rendering a page based on that file (and herein a “display list”). The method renders a section at a time, and renders each section by separately rendering each sub-section. In one implementation, the sub-sections are rendered sequentially. Illustrative apparatus that perform the method described herein are described with reference to FIGS. 3 and 4.

In block 610, a page is partitioned into sections and sub-sections. In block 620, a display list is built by converting a page representation (e.g. a PDL page representation) into the display list. For efficiency, the page display list is generally comprised of separate display lists, a separate display list for each section. Hereafter, a separate display list for a section is termed a section display list. As described with reference to FIG. 3, a section display list may be developed by converting a PDL description into rendering commands for those entities that fall totally or partially within the section. The entities are clipped to include the portions that fall within a section, and to exclude the portions that fall outside the section. Each section display list may be created separately from the other section display lists, and be separately stored in memory independently of the other display lists. Once a section display list has been used to develop a raster image of each sub-section, the section display list may be overwritten in memory by other data, including another section display list.

In block 630, a section of a page is rendered into a raster image by separately rendering each sub-section of the section. A section is rendered based on the section display list. The section is rendered by separately rendering each sub-section of the section based on the display list for that section. A raster image of each sub-section is separately developed. In one implementation, sub-section raster images are combined after they are developed. In one implementation, each sub-section raster image is combined to form a section raster image. In block 640, after the section raster image is rendered, the raster image is provided to a print engine. Yet in one more implementation, a sub-section raster image is provided to the print engine separately and independently of other sub-section raster images, or in conjunction with less than all the sub-section raster images. In one implementation, while a section raster image is sent to the print engine, another section raster image is being rendered. In one implementation, while a section raster image is sent to the print engine, another section raster image is being rendered.

In block 650, if there is a section still to be rendered, the “YES” branch is taken from block 650 to block 660 where the next section to be rendered is a section not yet rendered, and blocks 630-650 are repeated for the next section. In block 650, if there is not a section still to be rendered, (i.e. the “NO” branch is taken from block 650), then the page has been rendered.

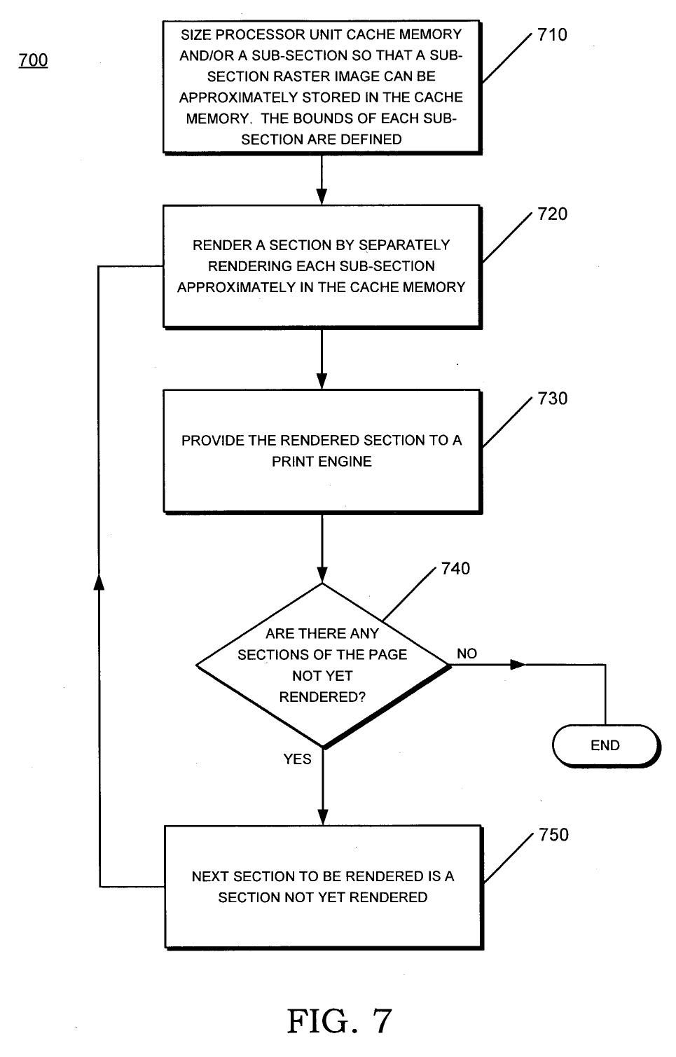

Referring now to FIG. 7, there is shown an exemplary method 700 of rendering a page, by rendering each sub-section separately so that the pixels of each sub-section raster image are approximately developed in the processor unit's cache memory. Illustrative apparatus that perform the method described herein are described with reference to FIGS. 3 and 4.

In block 710, a processor unit cache memory and/or a sub-section is sized so that a sub-section raster image size is generally less than the cache memory size, and the pixels of the sub-section raster image can be at least approximately stored in the cache memory while it is rendered. The bounds of each sub-section are defined in accordance with the sub-section size and the bounds of each section. As described with reference to FIG. 3, the cache memory operates at a faster speed than the main memory. Typically in an implementation, the cache is a given size. The sub-section is then sized so that sub-section raster image size is less than cache memory size. In one implementation, the sub-section is sized before rendering the sub-section by the execution of the processor 330 according to the size of the cache memory. As described with reference to FIG. 3, the more recently accessed instructions and data are stored in the cache. The cache memory thus stores the more frequently accessed sub-section raster image data, and other frequently accessed data and instructions while a sub-section is rendered.

In block 720 a section is rendered. Typically the section is rendered based on the display list for that section or other representation of a page to be printed. The section is rendered by separately rendering each sub-section of the section based on the display list for that section. A raster image of each sub-section is separately rendered. Each sub-section raster image is approximately stored in the cache memory, because the more frequently accessed data and instructions are stored in the cache memory, and the sub-section raster image and/or the cache memory have been sized so that the sub-section raster image size is at least approximately less than the cache memory size. In one implementation, each sub-section is rendered based on the section display list as described with reference to FIG. 6. In block 730, after the section raster image is rendered, the raster image is provided to a print engine. In one implementation a sub-section raster image is separately provided to the print engine and independently of other sub-section raster images, or in conjunction with less than all the sub-section raster images. In block 740, if there is a section still to be rendered, the “YES” branch is taken from block 740 to block 750 where the next section to be rendered is a section not yet rendered, and block 720-740 is repeated for the next section. In block 740, if there is not a section still to be rendered, (i.e. the “NO” branch is taken from block 740) then the page has been rendered.

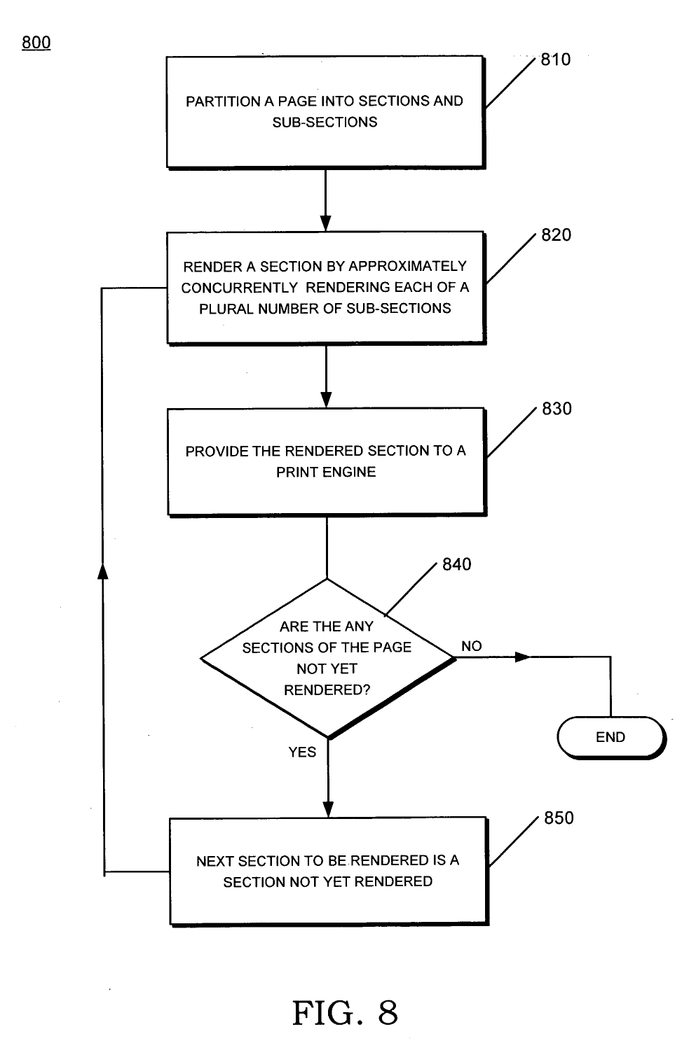

Referring now to FIG. 8, there is shown an exemplary method of rendering a page, by rendering sub-sections concurrently, using multiple processors. Illustrative apparatus that perform the method described herein is described with reference to FIG. 4. As described with reference to FIG. 4, an apparatus to concurrently render multiple sub-sections where each sub-section is rendered into a separate memory, is an apparatus having multiple processors each configured to render a sub-section, and each operatively coupled to a dedicated memory in which a sub-section is rendered. As described further with reference to FIG. 4, an illustrative apparatus to concurrently render multiple sub-sections has an operatively coupled cache memory which stores each sub-section raster image as it is rendered.

In block 810, a page is partitioned into sections and sub-sections. In block 820, a section of a page is rendered into a raster image by concurrently rendering each sub-section. A section is rendered based on the section display list. The section is rendered by separately rendering each sub-section of the section based on the display list for that section. In one implementation, sub-section raster images are combined after they are developed. In one implementation, each sub-section raster image is combined to form a section raster image. In one implementation each sub-section may be rendered into a separate memory. As described with reference to FIG. 7, in one implementation the more frequently accessed pixels are rendered in a cache memory, and in one implementation each sub-section is approximately rendered in a cache memory. In one implementation, groups of sub-sections are rendered concurrently, but all sub-sections are not rendered concurrently.

In block 830, after the section raster image is rendered, the raster image is provided to a print engine. In one implementation a sub-section raster image is separately provided to the print engine independently of other sub-section raster images, or in conjunction with less than all the sub-section raster images. In one implementation, while a section raster image is sent to the print engine, another section raster image is being rendered. Yet in one other implementation, while a section raster image is sent to the print engine, another section raster image is being rendered. In block 840, if there is a section still to be rendered, the “YES” branch is taken from block 840 to block 850 where the next section to be rendered is a section not yet rendered, and block 820-840 is repeated for the next section. In block 840, if there is not a section still to be rendered, (i.e. the “NO” branch is taken from block 840) then the page has been rendered.

The phraseology and terminology used is for the purpose of description and should not be regarded as limiting. Moreover, it is understood that the depicted acts in any described or claimed method are not necessarily order dependent, and may also be coincident.

The present invention is not limited by what has been particularly shown and described herein above. The specific features and operations are disclosed as exemplary forms of implementing the claimed subject matter. Therefore, the scope of the invention is defined by the claims which follow.

We claim:

1. A method of rendering a page comprising:
partitioning a page into sections;
partitioning individual sections into sub-sections; and
rendering individual sub-sections of a section into a sub-section raster image that together form a section raster image.

2. The method of claim 1 further comprising providing the section raster image to a print engine.

3. The method of claim 2 wherein the providing action comprises providing each sub-section raster image to the print engine.

4. The method of claim 1 further comprising:
providing the sub-section raster image to a print engine; and
repeating the rendering and the providing actions for each section of the page.

5. The method of claim 1 further comprising building a display list, and wherein the rendering is based on the display list.

6. The method of claim 5 wherein the building action comprises building a display list for each of the sections, and the rendering action comprises rendering each sub-section based on the display list for the section.

7. The method of claim 5 further comprising receiving a description of the page wherein the building a display list is based on the received description of the page.

8. The method of claim 1 further comprising caching pixels, and wherein the rendering action uses cached pixels.

9. The method of claim 8 wherein the rendering action is according to at least one of a replacement algorithm and explicit program instructions.

10. The method of claim 8 wherein the caching action comprises caching approximately frequently accessed pixels.

11. The method of claim 1 wherein the rendering action comprises concurrently rendering sub-sections.

12. The method of claim 11 wherein the rendering action is performed by multiple processors, each processor rendering at least one sub-section

13. A rendering device comprising:
a memory;
a processor operationally coupled to the memory;
a routine stored in the memory that when executed by the processor, causes the processor to perform actions comprising rendering a section of a page in the memory by separately rendering each of multiple sub-sections of the section for each other section of the page.

14. The rendering device of claim 13 wherein the processor comprises multiple processors each configured to perform the rendering of a sub-section concurrently with one another.

15. The rendering device of claim 13 wherein the memory includes a cache memory and the processor is operationally coupled to the cache memory.

16. The rendering device of claim 13 wherein the processor comprises multiple processors and the memory includes multiple cache memories, and each cache memory is operatively coupled to a separate processor.

17. The rendering device of claim 16 wherein each cache memory is of a size to store more frequently accessed pixels of a sub-section raster image when rendering a sub-section.

18. The rendering device of claim 16 wherein each cache memory is of a size so pixels of the sub-sections are approximately rendered in the cache memory.

19. The rendering device of claim 16 wherein the routine further causes the processors to execute a cache replacement algorithm, and wherein each sub-section and each cache memory is sized such that in rendering the sub-section, the cache replacement algorithm causes the processor to at least approximately render more frequently accessed pixels of the sub-section in the cache memory.

20. The rendering device of claim 19 wherein the building a display list comprises building a separate display list for each section of the page, and wherein the rendering each sub-section is based upon the display list for the section.

21. The rendering device of claim 13 wherein the processor comprise multiple processors configured to operate concurrently, such that the multiple sub-sections of the section are approximately rendered concurrently.

22. The rendering device of claim 13 wherein the actions further comprise building a display list representing a page; and the rendering of each sub-section is based upon the display list.

23. A printing device comprising:
a memory including a cache memory;
a processor operatively coupled to the cache memory; and
a routine stored in the memory that when executed by the processor unit, causes the processor unit to perform actions including rendering a section of the page by separately rendering each of multiple sub-sections of the section, and repeating the rendering action for each other section of the page.

24. The printing device of claim 23 further comprising a print engine operatively coupled to the processors, and the routine causes the processor to perform actions further comprising providing the rendered section to a print engine, and wherein the repeating includes repeating the providing action.

25. The printing device of claim 24 wherein the providing action comprises providing each sub-section to the print-engine.

26. The printing device of claim 23 wherein the rendering of a section is based on a display list of the section.

27. The printing device of claim 23 wherein at least one of the cache memory and the sub-section are sized such that the cache memory can store at least most pixels of a sub-section raster image.

28. The printing device of claim 23 wherein at least one of the cache memory and the sub-section are sized such that the cache memory can store at least the most frequently accessed pixels of a sub-section raster image.

29. The printing device of claim 33 wherein the routine causes the processor to perform actions further comprising sizing the sub-section according to the size of the cache memory.

30. The printing device of claim 23 further comprising an element to cause the cache to approximately store more recently executed instructions and data of the processor in the cache memory.

31. The printing device of claim 30 wherein the element is an executing algorithm.

32. The of claim 31 wherein the algorithm is a routine stored in the memory.

33. The printing device of claim 23 wherein the section raster image includes the sub-section raster images.

34. A rendering device comprising:
a memory;
multiple processors operatively coupled to and sharing the memory, and each of the processors configured to operate concurrently with the other processors; and
a routine stored in the memory that when executed by any one of the processors causes the processor to perform actions including rendering a separate sub-section of a section of a page.

35. The rendering device of claim 34 wherein the routine further causes the processors to perform actions including rendering a section of the page by separately rendering each of the sub-sections of the section, and repeating the rendering action for each other section of the page.

36. The rendering device of claim 34 further comprising multiple dedicated memories, wherein each of the processors is operatively coupled to a separate one of the dedicated memories.

37. The rendering device of claim 36 wherein the routine further causes each of the processors to render a sub-section in the coupled dedicated memory.

38. The rendering device of claim 37 wherein each dedicated memory comprises a cache memory and the routine causes each of the processors to render a sub-section approximately in the cache memory.

39. The rendering device of claim 37 wherein each dedicated memory comprises a cache memory and the routine causes each of the processors to render more frequently accessed pixels in the cache memory.

40. The rendering device of claim 34 wherein the quantity of sub-sections of the section is the same as the quantity of the processors.

41. A rendering device comprising:
multiple processors operatively coupled to a separate dedicated memory, each of the processors configured to operate concurrently with the other processors;
the dedicated memories; and
a routine stored separately in each of the memories that when executed by each processor causes the processor to perform actions including rendering at least one separate sub-section of a section.

42. The rendering device of claim 41 wherein the routine further causes the processors to perform actions including rendering a section of the page by separately rendering each of the sub-sections of the section, and repeating the rendering action for each other section of the page.

43. The rendering device of claim 41 wherein the routine further causes each of the processors to render a sub-section in the coupled dedicated memory.

44. The rendering device of claim 44 wherein the dedicated memory comprises a cache memory.

45. The rendering device of claim 44 wherein each of the processors renders at least more frequently accessed pixels of the sub-section is the cache memory.

46. The rendering device of claim 44 wherein each of the processors approximately renders the sub-section is the cache memory.

47. The rendering device of claim 41 wherein the quantity of the sub-sections of the section is the same as the quantity of the processors.

48. A computer readable media having stored thereon a routine that, when executed by at least one processor, cause the processor to perform actions comprising:
rendering a raster image of a section by separately rendering each of a plural quantity of raster images of sub-sections of the section; and
repeating the rendering and the providing actions for each section of the page.

49. The media of claim 48 wherein the routine causes the processor to perform actions further comprising providing the raster image of the section to a print engine.

50. The media of claim 48 wherein the routine further causes the processor to perform actions comprising rendering each sub-section based on a display list for the section.

51. The media of claim 50 wherein the routine further causes the processor to perform actions comprising controlling storing more frequently accessed data and instructions in a cache memory.

52. A computer readable media having stored thereon a routine that, when executed by at least one processor, cause the processor to perform actions comprising:
partitioning a page into sections;
partitioning individual sections into sub-sections; and
rendering individual sub-sections of a section into a sub-section raster image that together form a section raster image.

53. The media of claim 52 wherein the routine causes the processor to perform actions further comprising providing the section raster image to a print engine.

54. The media of claim 53 wherein the providing action comprises providing each sub-section raster image to the print engine.

55. The media of claim 52 wherein the routine causes the processor to perform actions further comprising:
providing the sub-section raster image to a print engine; and repeating the rendering and the providing actions for each section of the page.

56. The media of claim 52 wherein the routine causes the processor to perform actions further comprising building a display list, and wherein the rendering is based on the display list.

57. The media of claim 56 wherein the building action comprises building a display list for each of the sections, and the rendering action comprises rendering each sub-section based on the display list for the section.

58. The media of claim 57 wherein the routine causes the processor to perform actions further comprising receiving a description of the page wherein the building a display list is based on the received description of the page.

59. The media of claim 52 wherein the routine causes the processor to perform actions further comprising caching pixels, and wherein the rendering action uses cached pixels.

60. The media of claim 59 wherein the rendering action is according to at least one of a replacement algorithm and explicit program instructions.

61. The media of claim 59 wherein the caching action comprises caching approximately frequently accessed pixels.

62. The media of claim 52 wherein the rendering action comprises concurrently rendering sub-sections.

63. The media of claim 62 wherein the rendering action is performed by multiple processors, each processor rendering at least one sub-section

64. A device comprising:
means for partitioning a page into multiple sections;
means for partitioning individual sections into multiple sub-sections; and
means for rendering a section of the page by separately rendering individual sub-sections of the section.
